(19) United States
(12) Patent Application Publication
(10) Pub. No.: US 2002/0088869 A1
(43) Pub. Date: Jul. 11, 2002

(54) Fountain displays comprising dual entry nozzle laminar dispersal streams

(76) Inventor: Thomas R. Simmons, Dickinson, TX (US)

Correspondence Address: Marvin J. Marnock, 13630 Indian Creek Rd., Houston, TX, 77079, US

(21) Appl. No.: 09/932,488

(22) Filed: Aug. 18, 2001

Related U.S. Application Data
(60) Provisional application No. 60/226,555, filed on Aug. 21, 2000.

(51) Int. Cl. B05B 17/08

(52) U.S. Cl. 239/17

(57) ABSTRACT

A fountain apparatus for producing fountain dispersal streams emitted in parallel laminar relation, said apparatus including at least one nozzle comprising an outer tubular member and at least one other tubular member mounted inside thereof and wherein all of said tubular members are disposed with their longitudinal axes in parallel relation whereby their dispersal streams are in substantially parallel relation to one another when emitted, valve means for controlling the flow of liquid to each said nozzle, said valve means each having an inlet adapted for connection in fluid communication with a source of liquid under pressure and having valve outlet means comprising at least a pair of outlets, conduit means for connecting each of said valve outlets with a different one of the nozzle tubular member inlets, and means for operating said plurality of valve means to selectively control the degree of fluid communication between each of said valve outlets and said conduit means whereby when said valve inlet means are connected in fluid communication with a source of liquid under pressure, the plurality of valve means may be actuated to control the movements of the fountain dispersal streams.

This application claims the benefit of U.S. Provisional Patent Application No. 60/226555 filed on Aug. 21, 2000.

### FIELD OF THE INVENTION

The invention relates to apparatus for producing fountain displays and more particularly to apparatus for producing fountain dispersal streams in laminar relationship. The apparatus comprises one or more nozzles, each of which comprises at least one pair of tubular members in parallel axial relationship, one inside the other, and in which pair both tubular members are each independently connected by its own associated conduit to a source of fluid pressure through an alternating diverter valve installed for independently controlling the flow of fluid through each of the tubular members.

### BACKGROUND OF THE INVENTION

Fountains are customarily designed to produce spectacles which are aesthetically pleasing and entertaining. The fountain sprays or dispersal streams may be adapted to move in periodic and synchronized fashion for producing moving images and may include the use of light beams of different colors which are played on the fountain streams and sprays, oftentimes accompanied by music. Apparatus for producing variable-play fountain sprays is disclosed in U.S. Patent Reissue 35,866 and multi-entry nozzles adaped to produce “fan-like” and “stick-like” dispersal streams are disclosed in U.S. Pat. Nos. 4,177,927 and 5,524,822, respectively.

### SUMMARY OF THE INVENTION

It is well known by the “inversion of the jet” principle that the nozzle dispersal stream from a length tube such as a flattened tube is a dispersal which will invert 180° soon after departure from the tube end. At greater distances from the tube end, the stream will also continue to reinvert in accordance with the source pressure and the velocity of the dispersal.

The present invention concerns the generation and control of fountain dispersal streams, one inside the other in parallel axial relationship, to create unusual and interesting displays. The apparatus of the invention for generation of the dispersal streams comprises a first tube and a second tube disposed inside the first tube in parallel axial spaced relation therewith such that the outer diameter periphery of the inner tube is less than the inner diameter or inner dimension of the interior surface of the outer tube. Each of the tubes is connected by a conduit or flexible hose, such that the conduits or hoses respectively connect each of the tubes to the dual outlets of an alternating diverter valve, the inlet of which is connected to a source of fluid pressure, for example, the outlet of a pump which intakes water from a reservoir or other water supply.

### BRIEF DESCRIPTION OF THE DRAWINGS

FIG. 1A is a perspective schematic view of an apparatus comprising a nozzle having a pair of coaxially disposed tubes and adapted for generation and control of coaxially dispered streams in accordance with the invention;

FIG. 1B is a perspective fragmentary view of an apparatus in accordance with the invention which comprises a nozzle having a multiplicity of coaxially disposed nozzle tubes;

FIGS. 2a, 2b and 2c are fragmentary views of nozzle tubes, each having a transverse cross section other than circular and which can be used in a variety of combinations, one inside the other, to provide a nozzle in the apparatus of the invention;

FIGS. 2d-2i are perspective fragmentary views of nozzles comprising coaxially disposed flow tubes in various relationships wherein at least one of the flow tubes ina coaxial arrangement has a transverse cross section other than circular and which nozzles cam be used in the invention;

FIG. 3 is a detailed view, partly in cross section, of an alternating valve which can be used as a diverter valve for controlling the flow of liquid to the tubes of a nozzle for generating laminar dispersal streams by the apparatus of the invention;

FIG. 4 is a schematic view of a dual entry nozzle having a pair of entry tubes arranged in a “V” shape with an exit aperture at their apex, each tube each outer tube having an inner tube disposed coaxially therein and the pairs of inner tubes and outer tubes are connected to a pressurized source of liquid and adapted to provide an oscillating dispersal stream;

FIG. 5 is a schematic view of a multiple entry nozzle comprising multiple entry tubes, each having an inner tube coaxially disposed therein, and which nozzle may be used in an embodiment of the invention for producing complex movements of the dispersal stream;

FIG. 6 is a schematic view of a fountain display incorporating the invention in which a plurality of water dispensing nozzles are mounted in a linear array above a linear array of oil dispensing nozzles;

FIGS. 7, 8 and 9 are perspective views of fountain displays,each incorporating the apparatus of the invention, wherein a plurality of dual entry valves are mounted in overhead supports to provide gravity assisted downwardly directed laminar dispersal streams;

FIG. 10 is a perspective fragmentary view of a nozzle in which an air tube is mounted in coaxial relation with an outer tube and which could be used in the apparatus of the invention; and

FIGS. 11 and 12 are perspective fragmentary views of additional nozzle arrangements which can be used in the invention.

### DETAILED DESCRIPTION OF THE INVENTION

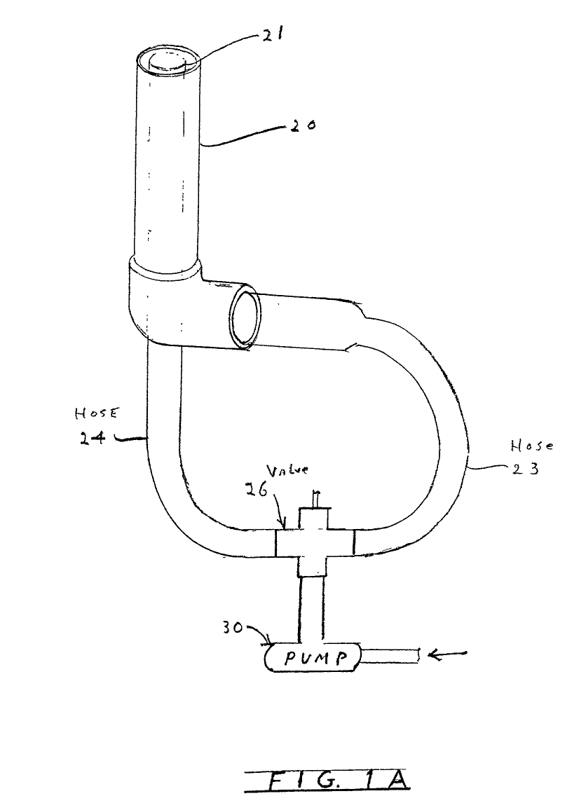

Referring more particularly to the drawings, an apparatus for generation of coaxial laminar dispersal streams is shown in FIG. 1. The apparatus comprises a first tube 20 and a second tube 21 disposed inside the tube 20 in coaxial spaced relation therewith such that the outer diameter of the tube 21 is less than the inner diameter of the outer tube 20. Each of the tubes 20, 21 is connected by a conduit or hose, such as the flexible hoses 23, 24 which connect respectively the tubes 20 and 21 to the dual outlets of an alternating diverter valve 26, the inlet of which is connected to a source of fluid pressure, for example, the outlet of a pump 30 which intakes water from a reservoir of other water supply.

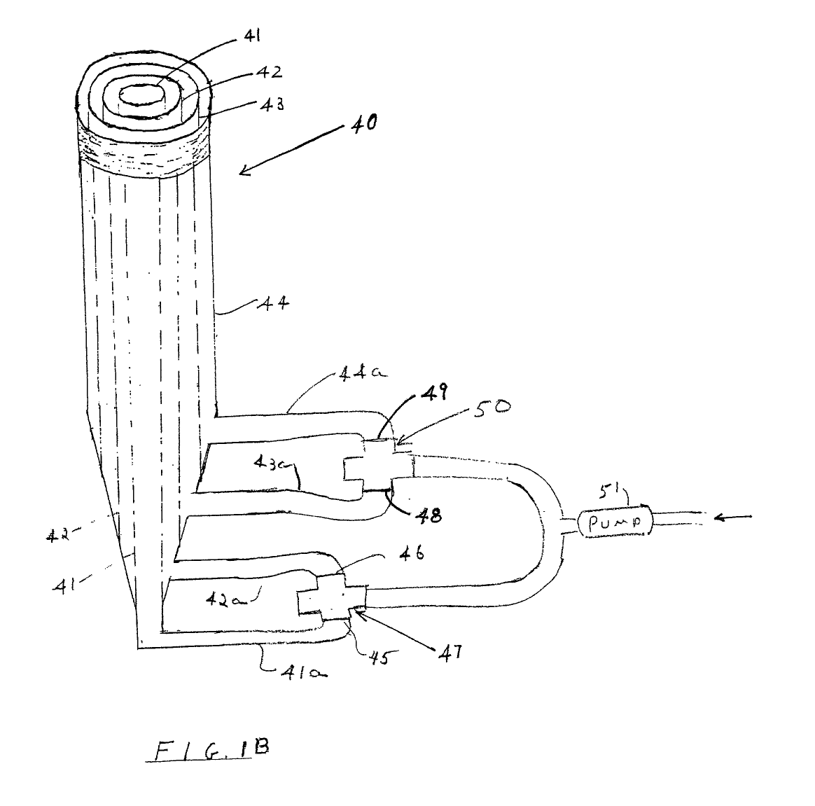

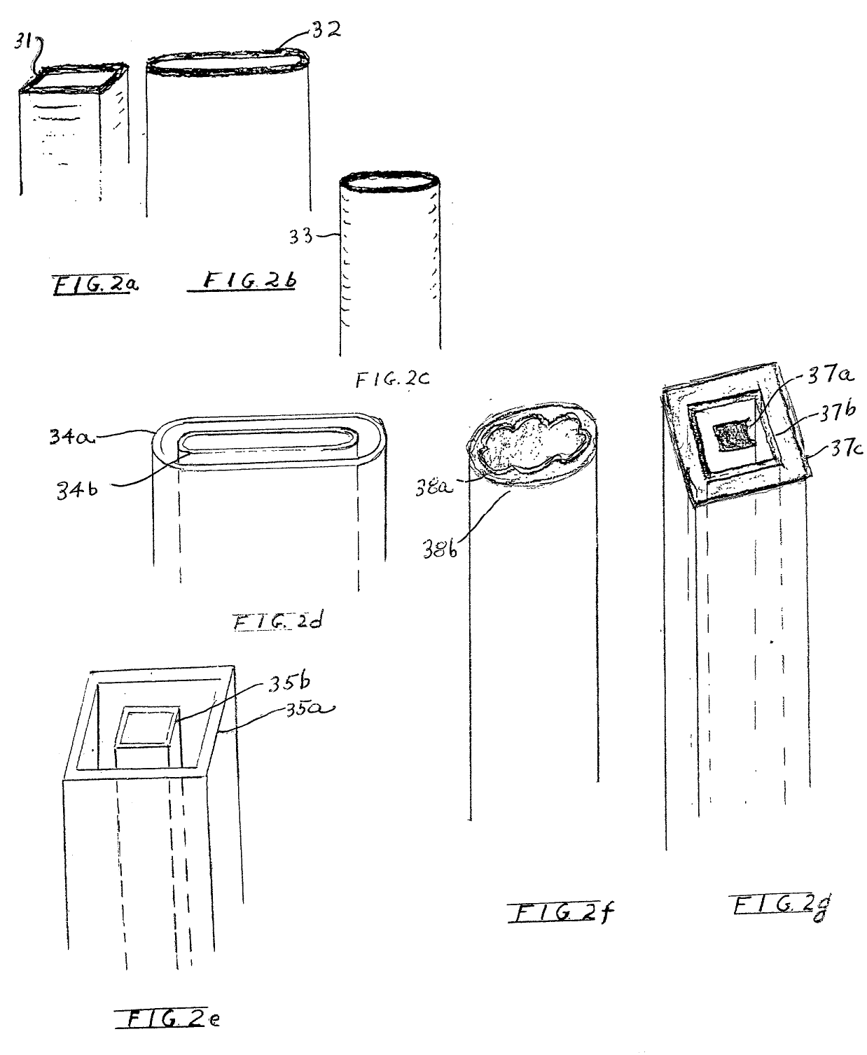

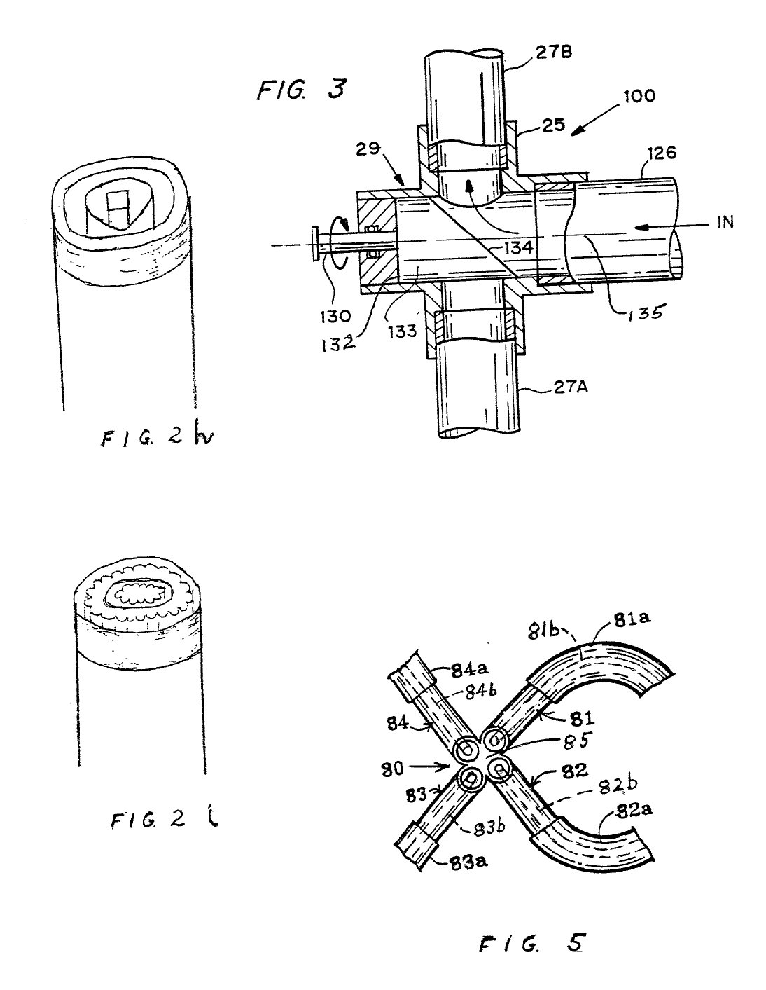

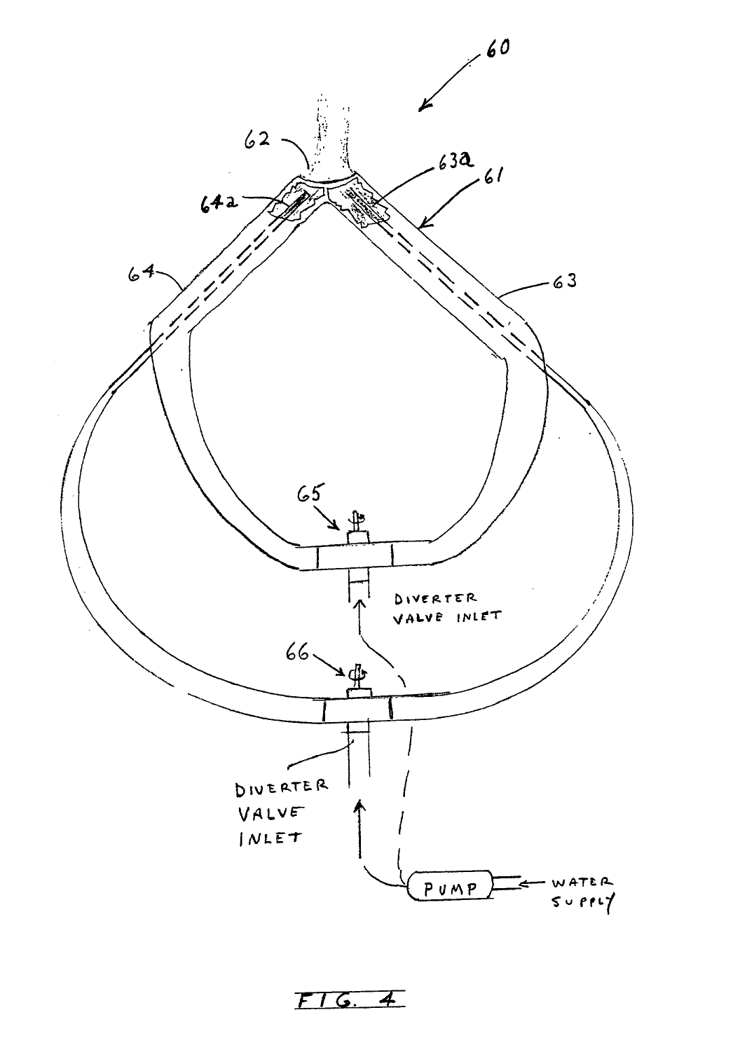

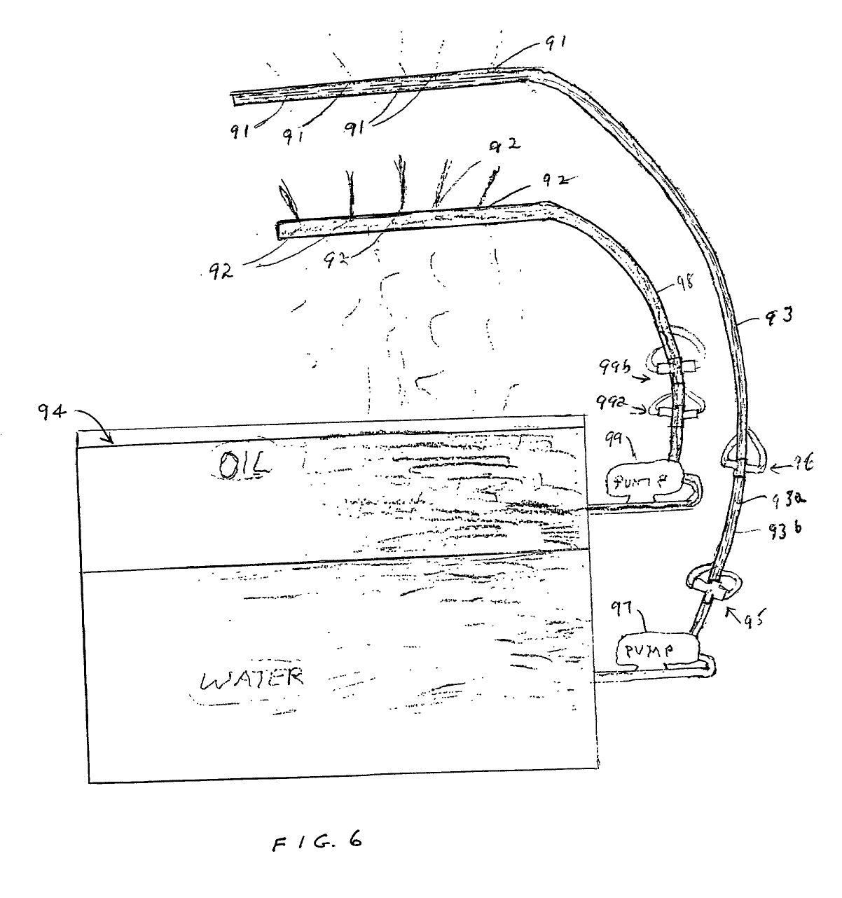

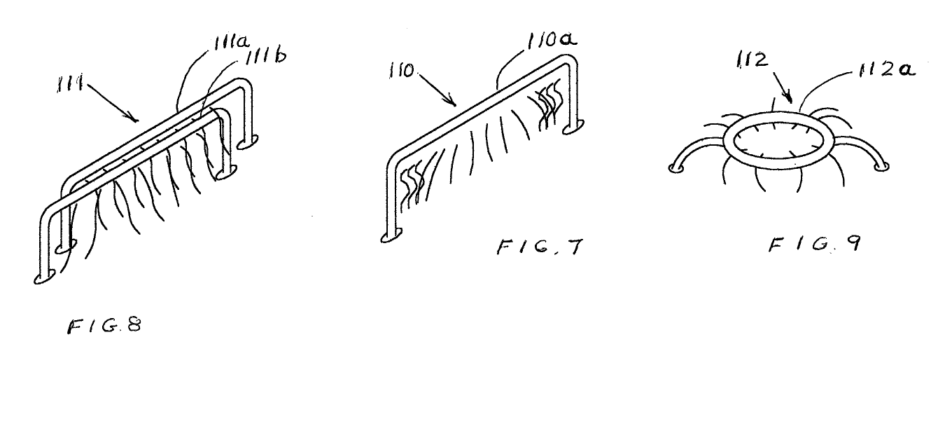

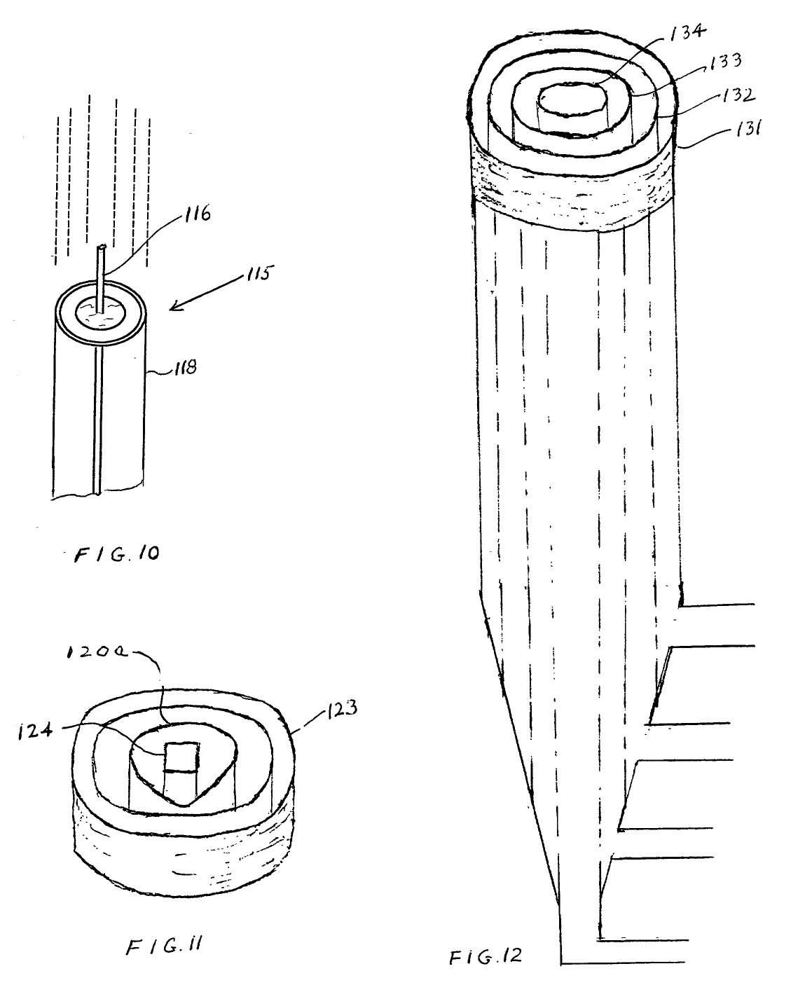

By the apparatus of the invention to be hereinafter described, it is possible to vary the heights of the dispersal streams from the tubes 20 and 21. The heights may be adjusted in synchronism or asynchronously, and if desired, reduced to zero to produce beautiful and unusual fountain displays. For example, should the dispersal stream from the inner tube 21 be reduced to zero while the outer tube dispersal continues, the circumference of the outer dispersal stream will slowly decrease as its water is slowly sucked inward so as to fill the induced vacuum caused by the absence of the tube 21 dispersal. While this is occurring, by the principle of the inversion of the jet, 180° axial rotations of the stream will occur at different distances from the tube nozzle end, as would be especially displayed by dispersals from the tubes of nozzles which are other than circular in transverse cross section, such as the nozzles shown in FIGS. 2a-2i. While such tubes are typically rigid, made of steel or the like, they may also be made of rubber or the like so as to change shape in transverse cross section when high pressure liquid flows through the coaxial or axially parallel tubes of non-circular cross section.

The tubes 31, 32 and 33 shown in FIGS. 2a, 2b and 2c respectively can be used in different axially parallel arrangements to provide coaxial or axially parallel dispersal streams. In FIG. 2d, the coaxial tubes 34a, 34b are each designed with parallel sides and rounded ends. Coaxial tubes 35a, 35b of square cross section are shown in a nozzle in FIG. 2e. Similar tubes 37c, 37b are shown in a nozzle in FIG. 2g which may include a third coaxial member 37a, which might be a solid rod or tube of square transverse cross section. The nozzle in FIG. 2f includes an outer tube 38b of circular cross section and an inner coaxial tube 38a having multiple corrugations.

Referring to FIG. 3 there is shown in detailed pictorial representation, partly in cross section, an alternating valve 100 depicted in FIG. 1 as valve 26. More particularly, the valve 100 may be seen to comprise a four-way tubular body member 29 having a port for receiving water through the conduit 126, a port interconnected with conduit 27a and a third port interconnected with conduit 27B. The alternating valve 100 performs its function in response to rotation of the shaft 130 at a constant or varying rate and in either direction which may be done manually or by motor (not shown). Accordingly,the four-way tubular housing of the alternating valve is further provided with a fourth outlet for sealingly accepting the free-traveling of the shaft 130 which, in turn, is fixedly connected at one end to the planar end 132 of a frusto-conical member hereinafter referred to as valve element 133 which is a cylindrical member having a canted end surface 134 for confronting the stream of water issuing from the pump and delivered through the conduit 126. When valve element 133 is axially revolved about its axis 135 so that its canted surface 134 faces conduit 126 and also the conduit 127b (as illustrated in FIG. 3) the imput to conduit 27a will be blocked and all flow through conduit 126 will be diverted into conduit 27B. Alternatively, when the shaft 130 rotates 180 degrees to revolve the valve element 133 within the four-way tubular housing 29, the canted surface 134 of the element 133 will be positioned to divert water from the conduit 126 into the conduit 27A, and all flow from conduit 126 will be blocked from the conduit 27B.

The effect of revolving the valve element 133 continuously in one direction is to vary the pressure and volume of water to the outlet conduits 27A, 27B. If such a valve is provided for valve 26 in the apparatus of FIG. 1 and its valve element continuously rotated, it is to be noted that flow to the respective hoses 23 and 24 will vary correspondingly, one having an increasing flow as the other decreases in flow amd the streams from tubes 20 and 21 controlled accordingly. The valve shaft 130 might also be reversed in rotational direction at any time and its speed of rotation varied as desired to provide for many possible variations in movements of the coaxial dispersal streams, as for example, in their up and down movements when the nozzles are positioned to eject vertically.

Other embodiments of the invention comprise nozzles having a multiplicity of coaxial tubes such as the nozzle 40 shown in FIG. 1B wherein tubes 41, 42, 43 and 44 are mounted in coaxial spaced relation to one another. For any one pair of the tubes, flow to the tubes is controlled by an alternating diverter valve such as the valve 26 shown in FIG. 1A. In the nozzle 40, flexible hoses or conduits 41a, 42a connect the tubes 41 and 42 respectively to the outlet ports 45, 46 of an alternating diverter valve 47. In similar fashion, conduits 43a, 44a connect the tubes 43 and 44 to the outlet ports 48, 49 of an alternating diverter valve 50. The inlets of the valves 47, 50 are connected to the outlet of a pump 51 which intakes water from an appropriate water supply (not shown). It is also to be appreciated that the tubes selected for a pair might be other than shown, as for example, tubes 41 and 43 in a first pair and tubes 42, 44 in a second pair. Irrespective as to the paired selection, the dispersal streams from each tube in a pair may be varied as desired as the water pressure to each tube is varied by the associated diverter valve. In addition, the dispersal streams of one pair may also be varied with respect to the dispersal streams of the other pair.

It is also to be appreciated that the transverse cross section of any of the tubes might be other than circular such as shown by the nozzles of FIGS. 2a-2i. If desired, the wall thicknesses and transverse cross section areas of the tubes may vary with respect to one another and in lieu of water, fluids such as oil and air, of any desired color and consistency might be used with the nozzles of the invention to provide colorful dispersals. At some predetermined distance from the nozzle tip, the multiple coaxial streams will adhere to each other and invert 180°. It is therefore possible with the nozzles as shown in FIGS. 2f to 2i to create an interesting ever changing dispersal that might be compared to the rapid blooming and fading of a flower and with constant renewal.

The different embodiments of the invention as heretofore described all produce substantially straight , unidirectional nozzle dispersal streams. In FIG. 4, there is shown a dual entry nozzle 60 comprising a V-shaped tube 61 with an exit aperture 62 at the apex of the tube. When two pressured flows are delivered to the dual inlets at opposite ends of the tube 61, they are merged just outside the exit aperture 62 at a location which can be adjusted by changing the angle of juncture of the legs 63, 64 of the V-shaped tube 61. The dual entry nozzle is particularly suited for use where a back-and forth motion of the dispersal stream is desired, which can be accomplished by selectively increasing the flow to one inlet conduit as compared with the flow to the other, or to re-position the nozzle dispersal stream in an instantaneous manner by abruptly transferring a full pressure flow from one inlet port to the other. As shown in U.S. Pat. Nos. 4,962,921 and 5,918,809, an alternating diverter valve 65 may be used to control flow to the dual inlets of a dual entry nozzle, and thereby provide for an oscillating movement of the “stick-like” nozzle dispersal stream. For providing coaxial dispersal streams, the nozzle 60 is also provided in each of the legs 63, 64 of its V-shaped tube 61, with a coaxial tubular member, such as the tubes 63a, 64a. The outlet ends of the tubes 63a, 64a are disposed closely adjacent the exit aperture 62 such that the dispersal streams which issue from tubes 63a, 64a are merged substantially at the exit aperture and form a stream inside of and in coaxial relation to the dispersal stream from the tube 61. A separate alternating valve 66 is provided for controlling the flow to the inlets of the tubes 63a, 64a and when operated in synchronism with the valve 65 The merged dispersal streams from the tubes 63a, 64a can be moved in synchronism with the merged dispersal streams from the tubular legs 63, 64 in coaxial relation therewith.

The provision of a separate alternating diverter valve 66 for controlling flow to the inner tubes 63a, 64a makes it possible to completely shut off flow to these inner tubes while a dispersal stream is produced from the outer tubes 63, 64 thereby producing an interesting laminar dispersal from the exit, which dispersal while moving in oscillation will be affected by the “inversion of the jet” principle. However, it is to be appreciated that instead of the pair of diverter valves 65, 66, a single diverter valve might be used wherein its dual outlets are connected to the four inlets of tubes 63, 64 and tubes 63a, 64a. With use of a single diverter valve, synchronism of the coaxial dispersal streams from the nozzle 60 is simplified.

For more complex movements of the dispersal stream, a multiple entry nozzle such as the nozzle 80 in FIG. 5 may also be used. In the nozzle 80, four linear tubes 81-84 are each at one end connected to larger diameter supply conduits 81a-84a, respectively, and arranged in a pyramidal relationship with their outlet ends joined to provide an exit aperture 85 at the apex of their pyramidal orientation, such that the dispersal streams emitting therefrom will merge at a location closely adjacent to the outlets to produce a single dispersal stream. By selectively varying the liquid flow in each of the conduits 81a-84a with respect to the others as by a pair of diverter valves, the merged dispersal stream may be made to move in a complex manner such as, for example, to describe a cone or similar geometric form by its movement.

As shown in FIG. 5, however, within each of the four linear tubes 81-84 is disposed a coaxial inner tube, tubes 81b-84b to which the liquid supplied thereto is also controlled by one or more diverter valves in a synchronism with the valves which control the flow to tubes 81-84. The merged dispersal stream from the inner tubes 81b-84b is therefore controllable in synchronism with the dispersal stream from the outer tubes 81-84 which is in coaxial sleeved relation therewith to a point of merger and inversion at a predetermined distance from the exit aperture 85.

It is also to be appreciated that a valve such as a readily reversible ball valve or a valve with a tubular valve element such as shown and described in U.S. Patent Reissue 35,866 might be used as an alternating diverter valve in lieu of the valve 29 of FIG. 3 for controlling flow to the tubular members and the nozzle dispersal streams in the various embodiments of the invention disclosed herein.

In FIG. 6 there is shown a fountain display in which a plurality of water nozzles 91 are mounted in a linear array above a linear array of oil dispensing nozzles 92. The nozzles 91 and 92 comprise nozzles such as the nozzle 60 which produces a moveable oscillating dispersal stream comprising axial dispersal streams. The linear arrays of nozzles 91 and 92 may also comprise nozzles which produce straight unidirectional dispersals such as the nozzle of FIG. 1A.

As shown in FIG. 6, the nozzles 92 are mounted in a tubular member 93 which extends upwardly and outwardly over a pool 94. Within the curved tube 93 are additional conduits 93a, 93b which are mounted therein. Each of the tubes 93, 93a, 93b is provided with branch outlets (not shown) to connect to the dual inlets of each dual entry nozzle 60. The inlet of a diverter valve 95 is connected to a pump 97 and its outlets to the conduit 93a which connects to the dual inlets of the inner and outer tubes of the nozzles 91. In similar fashion, a diverter valve 96 connects to the outlet of the pump 97 and delivers water to the conduit 93b which connects to the inlets of the inner coaxial tubes of each single entry nozzle which produces a straight dispersal.

The oil dispersal nozzles 92 such as the nozzle 60 of FIG. 4 are mounted in a similar fashion to the nozzles 91 but on a curved tubular member 98, and are preferably arrayed just below the nozzles 91 in parallel relation thereto. Oil is supplied to the nozzles 92 by a pump 99 via a pair of diverter valves 99a, 99b for feeding the outer tubes of each nozzle as well as the inner tubes mounted coaxially therein. In a modification of the display of FIG. 6, one of the diverter valves might be used to control all inlets od the dual entry nozzles while the other diverter valve might be used to control flow to the single entry nozzles.

For the display of FIG. 6, the water and oil may be of different colors to produce an intermixing of different colored dispersal streams especially when oscillating. The pump 99 is connected to draw oil which floats above the water in the pool and the inlet of pump 97 is connected to draw water therebelow. To enhance the display, colored lights may be used to illuminate the interacting nozzle dispersal streams. The lights might be mounted poolside or on the tubular member 93, 98.

Other displays 110, 111 and 112 with overhead dispersals are shown in FIGS. 7, 8 and 9. All dispersal streams are from concentric dual entry nozzles 60, such as the nozzle 60, mounted in overhead supports, 110a in FIG. 7, 111a and 111b in FIG. 8, and a circular support 112a in FIG. 9, and controlled by diverter valves such as the valve 100. The streams, gravity assisted, fall on a “splash-proof” stage 115, such as one made of porous air-conditioner filter material or a lattice-like structure which acts to minimize splashing and thereby provide a relatively quiet display.

In FIG. 10 there is shown a nozzle 115 in which an air tube 116 is mounted in coaxial relation with an outer tube 119. The tube 116 may have lateral perforations and could supply air to the annular liquid dispersal stream surrounding it when connected to a controllable off-and-on air supply. If an off-and-on variable speed pump is used it could constantly change the shape and size of the dispersal stream.

In FIGS. 11 and 12, additional nozzle arrangements 120 and 121 are shown which could also be used in the apparatus of the invention. In the nozzle 120, an inner tube of heart-shaped cross section , 120a, is coaxially mounted in an outer tube 123. A rod 124 is mounted inside the tube 120a and in coaxial relation to the tubes 123 and 120a.

In FIG. In FIG. 12 , the nozzle 121 comprises a plurality of coaxial and concentric tubes 131, 132, 133, and 134 . It is to be understood that the pressure of flow to each of the tubes can be changed constantly and the liquids to the tubes can be of different color and different varieties for providing a beautiful ever changing dispersal stream.

It is to be appreciated that the foregoing description of the invention has been presented for purpose of illustration and explanation and is not intended to limit the invention to the precise forms disclosed. For example, the several nozzles shown in the several Figures of the drawings might also be other than coaxial and concentric since concentricity is not a requirement for the nozzle of the invention. Accordingly, it is to be appreciated that various changes may be made in the apparatus by those skilled in the art without departing from the spirit of the invention.

I claim:

1. A fountain apparatus for producing fountain streams and sprays wherein the streams and sprays are emitted in laminar relationship to provide aesthetically pleasing and entertaining displays, said apparatus comprising:
a nozzle for discharging fountain liquid, said nozzle comprising at least a pair of tubular members mounted one inside the other with their longitudinal axes in parallel relation to one another, each tubular member having a nozzle entry port adapted to receive liquid therethrough and an exit aperture to allow the flow of liquid therethrough, said tubular members having their exit apertures in juxtaposition whereby their dispersal streams are in substantially parallel relation to one another when emitted;
valve means for controlling the flow of liquid, said valve means including inlet means adapted for connection in communication with a source of liquid under pressure and having valve outlet means comprising at least a pair of outlets;
conduit means for connecting each of said at least a pair of valve outlets with a different one of the entry ports of said nozzle tubular members; and
means for operating said valve means to selectively control the degree of fluid communication between said valve outlet means and said conduit means whereby when said valve inlet means is connected in fluid communication with a source of fluid under pressure, the valve means may be actuated to control the movements of said fountain dispersal streams.

2. A fountain apparatus as aet forth in claim 1 wherein said nozzle tubular members are disposed in coaxial relation to one another and their dispersal streams are emitted in coaxial laminar relationship to one another.

3. A fountain apparatus as set forth in claim 1 wherein said nozzle tubular members are of non-rigid material.

4. A fountain apparatus as set forth in claim 1 wherein at least one of said nozzle tubular members has a transverse cross section which is noncircular in geometric configuration.

5. A fountain apparatus as set forth in claim 1 wherein said nozzle tubular members have transverse cross sections which are different in geometrical configuration.

6. A fountain apparatus for producing fountain streams which are emitted in laminar relationship to provide aesthetically pleasing and entertaining displays, said apparatus comprising:
a nozzle for discharging fountain liquid, said nozzle comprising an outer tubular member and a plurality of other tubular members mounted inside thereof and wherein all of said tubular members have their longitudinal axes in parallel relation to one another, each said tubular member having a nozzle entry port adapted to receive liquid therethrough, said tubular members having their exit apertures positioned in relation to one another whereby their dispersal streams are in substantially parallel to one another when emitted;
a plurality of valve means for controlling the flow of lquid, each said valve means having an inlet adapted for connection in fluid communication with a source of liquid under pressure and having valve outlet means comprising at least a pair of outlets;
conduit means for connecting each of said valve outlets with a different one of the entry ports of said nozzle tubular members; and
means for operating said plurality of valve means to selectively control the degree of fluid communication between each of said valve outlet means and said conduit means whereby when said valve inlet means are connected in fluid communication with a source of fluid under pressure, the plurality of valve means may be actuated to control the movements of said fountain dispersal streams.

7. A fountain apparatus as set forth in claim 6 further comprising a plurality of sources of different colored liquids under pressure and wherein each of said plurality of valve means has an inlet connected in fluid communication with a different one of said sources of fluid under pressure.

8. A fountain apparatus as set forth in claim 6 wherein at least one of said nozzle tubular members has a transverse cross section which is different from the transverse cross sections of the other tubular members in geometrical configuration.

9. A fountain apparatus as set forth in claim 6 wherein some of said nozzle tubular members have a transverse cross section which differs from at least one of the others.

10. A fountain apparatus as set forth in claim 6 wherein at least one of said nozzle tubular members has a transverse cross section which is noncircular and differs in ransverse cross section from at least one of the others.
